(19) United States
(12) Patent Application Publication
(10) Pub. No.: US 2024/0394345 A1
(43) Pub. Date: Nov. 28, 2024

(54) DATA INTERACTION PROCESSING

(71) Applicant: Alipay (Hangzhou) Information Technology Co., Ltd., Hangzhou (CN)

(72) Inventors: Jincheng DU, Hangzhou (CN); Weikang ZHONG, Hangzhou (CN); Mingxing LI, Hangzhou (CN); Shasha MA, Hangzhou (CN); Qing HE, Hangzhou (CN); Ying HAO, Hangzhou (CN)

(21) Appl. No.: 18/797,384

(22) Filed: Aug. 7, 2024

Related U.S. Application Data
(63) Continuation of application No. PCT/CN2023/071247, filed on Jan. 9, 2023.

(30) Foreign Application Priority Data
Feb. 10, 2022 (CN) 202210125930.4

(51) Int. Cl. G06F 21/10

(52) U.S. Cl. CPC G06F 21/1082

(57) ABSTRACT

Implementations of the present specification provide a digital item transfer interaction processing method and apparatus. The digital item transfer interaction processing method includes: receiving a digital item transfer request submitted by a member terminal of a target member in a member group of an institution, where the digital item transfer request is generated after a digital item transfer interface configured for the member group is triggered; performing digital item transfer processing on digital item transfer information carried in the digital item transfer request, and obtaining a digital item transfer record; generating digital item transfer interaction messages of institutional members in the member group for the digital item transfer record based on member permission of the institutional members, where the digital item transfer interaction messages carry interaction tags of the corresponding institutional members; and performing digital item transfer interaction processing on a digital item transfer interaction request submitted by any institutional member based on an interaction tag, if the digital item transfer interaction request is received.

### TECHNICAL FIELD

The present specification relates to the field of data processing technologies.

### BACKGROUND

With the continuous development of the Internet and information technology, small and micro enterprises account for more than 99% of the total number of enterprises. They play a huge role in activating the market, increasing taxes, creating jobs, maintaining social stability, etc., and are an important force for economic development and healthy social development.

### SUMMARY

One or more implementations of the present specification provide a digital item transfer interaction processing method. The digital item transfer interaction processing method includes: receiving a digital item transfer request submitted by a member terminal of a target member in a member group of an institution, where the digital item transfer request is generated after an interface for the digital item transfer configured for the member group is triggered; performing digital item transfer processing on digital item transfer information carried in the digital item transfer request, and obtaining a digital item transfer record; generating digital item transfer interaction messages of institutional members in the member group for the digital item transfer record based on member permission of the institutional members, where the digital item transfer interaction messages carry interaction tags of the corresponding institutional members; and performing digital item transfer interaction processing on a digital item transfer interaction request submitted by any institutional member based on an interaction tag, if the digital item transfer interaction request is received.

One or more implementations of the present specification provide another digital item transfer interaction processing method, including: receiving a digital item transfer instruction submitted by a target member in a member group of an institution by triggering a digital item transfer interface of the member group; obtaining digital item transfer information collected for the digital item transfer instruction, generating a digital item transfer request, and submitting the digital item transfer request to a server; receiving a digital item transfer interaction message that is delivered by the server and that carries an interaction tag of the target member, and displaying the digital item transfer interaction message in an interaction list of the member group; and submitting a digital item transfer interaction request corresponding to the interaction tag to the server if it is detected that the interaction tag is triggered.

One or more implementations of the present specification provide a digital item transfer interaction processing apparatus, including: a request receiving module, configured to receive a digital item transfer request submitted by a member terminal of a target member in a member group of an institution, where the digital item transfer request is generated after a digital item transfer interface configured for the member group is triggered; a digital item transfer processing module, configured to: perform digital item transfer processing on digital item transfer information carried in the digital item transfer request, and obtain a digital item transfer record; a message generation module, configured to generate digital item transfer interaction messages of institutional members in the member group for the digital item transfer record based on member permission of the institutional members, where the digital item transfer interaction messages carry interaction tags of the corresponding institutional members; and an interaction processing module that is run if a digital item transfer interaction request submitted by any institutional member based on an interaction tag is received, where the interaction processing module is configured to perform digital item transfer interaction processing on the digital item transfer interaction request.

One or more implementations of the present specification provide another digital item transfer interaction processing apparatus, including: an instruction receiving module, configured to receive a digital item transfer instruction submitted by a target member in a member group of an institution by triggering a digital item transfer interface of the member group; a request submission module, configured to: obtain digital item transfer information collected for the digital item transfer instruction, generate a digital item transfer request, and submit the digital item transfer request to a server; a message display module, configured to: receive a digital item transfer interaction message that is delivered by the server and that carries an interaction tag of the target member, and display the digital item transfer interaction message in an interaction list of the member group; and an interaction request submission module that is run if it is detected that the interaction tag is triggered, where the interaction request submission module is configured to submit a digital item transfer interaction request corresponding to the interaction tag to the server.

One or more implementations of the present specification provide a digital item transfer interaction processing device, including a processor and a storage configured to store computer-executable instructions. When the computer-executable instructions are executed, the processor is enabled to perform the following operations: receiving a digital item transfer request submitted by a member terminal of a target member in a member group of an institution, where the digital item transfer request is generated after a digital item transfer interface configured for the member group is triggered; performing digital item transfer processing on digital item transfer information carried in the digital item transfer request, and obtaining a digital item transfer record; generating digital item transfer interaction messages of institutional members in the member group for the digital item transfer record based on member permission of the institutional members, where the digital item transfer interaction messages carry interaction tags of the corresponding institutional members; and performing digital item transfer interaction processing on a digital item transfer interaction request submitted by any institutional member based on an interaction tag, if the digital item transfer interaction request is received.

One or more implementations of the present specification provide another digital item transfer interaction processing device, including a processor and a storage configured to store computer-executable instructions. When the computer-executable instructions are executed, the processor is enabled to perform the following operations: receiving a digital item transfer instruction submitted by a target member in a member group of an institution by triggering a digital item transfer interface of the member group; obtaining digital item transfer information collected for the digital item transfer instruction, generating a digital item transfer request, and submitting the digital item transfer request to a server; receiving a digital item transfer interaction message that is delivered by the server and that carries an interaction tag of the target member, and displaying the digital item transfer interaction message in an interaction list of the member group; and submitting a digital item transfer interaction request corresponding to the interaction tag to the server if it is detected that the interaction tag is triggered.

One or more implementations of the present specification provide a storage medium, configured to store computer-executable instructions. When the computer-executable instructions are executed by a processor, the following procedure is implemented: receiving a digital item transfer request submitted by a member terminal of a target member in a member group of an institution, where the digital item transfer request is generated after a digital item transfer interface configured for the member group is triggered; performing digital item transfer processing on digital item transfer information carried in the digital item transfer request, and obtaining a digital item transfer record; generating digital item transfer interaction messages of institutional members in the member group for the digital item transfer record based on member permission of the institutional members, where the digital item transfer interaction messages carry interaction tags of the corresponding institutional members; and performing digital item transfer interaction processing on a digital item transfer interaction request submitted by any institutional member based on an interaction tag, if the digital item transfer interaction request is received.

One or more implementations of the present specification provide another storage medium, configured to store computer-executable instructions. When the computer-executable instructions are executed by a processor, the following procedure is implemented: receiving a digital item transfer instruction submitted by a target member in a member group of an institution by triggering a digital item transfer interface of the member group; obtaining digital item transfer information collected for the digital item transfer instruction, generating a digital item transfer request, and submitting the digital item transfer request to a server; receiving a digital item transfer interaction message that is delivered by the server and that carries an interaction tag of the target member, and displaying the digital item transfer interaction message in an interaction list of the member group; and submitting a digital item transfer interaction request corresponding to the interaction tag to the server if it is detected that the interaction tag is triggered.

### BRIEF DESCRIPTION OF DRAWINGS

FIG. 1 is a processing flowchart illustrating a digital item transfer interaction processing method according to one or more implementations of the present specification;

FIG. 2 is a schematic diagram illustrating an access page according to one or more implementations of the present specification;

FIG. 3 is a schematic diagram illustrating a single backup resource configuration page according to one or more implementations of the present specification;

FIG. 4 is a schematic diagram illustrating a cyclic backup resource configuration page according to one or more implementations of the present specification;

FIG. 5 is a schematic diagram illustrating a periodic backup resource configuration page according to one or more implementations of the present specification;

FIG. 6 is a schematic diagram illustrating a first resource display page according to one or more implementations of the present specification;

FIG. 7 is a schematic diagram illustrating a second resource display page according to one or more implementations of the present specification;

FIG. 8 is a schematic diagram illustrating a third resource display page according to one or more implementations of the present specification;

FIG. 9 is a schematic diagram illustrating an interaction list page according to one or more implementations of the present specification;

FIG. 10 is a schematic diagram illustrating another interaction list page according to one or more implementations of the present specification;

FIG. 11 is a schematic diagram illustrating a log recording page according to one or more implementations of the present specification;

FIG. 12 is a processing flowchart illustrating a digital item transfer interaction processing method applied to a write-off interaction scenario according to one or more implementations of the present specification;

FIG. 13 is a processing flowchart illustrating another digital item transfer interaction processing method according to one or more implementations of the present specification;

FIG. 14 is a schematic diagram illustrating a digital item transfer interaction processing apparatus according to one or more implementations of the present specification;

FIG. 15 is a schematic diagram illustrating another digital item transfer interaction processing apparatus according to one or more implementations of the present specification;

FIG. 16 is a schematic structural diagram illustrating a digital item transfer interaction processing device according to one or more implementations of the present specification; and

FIG. 17 is a schematic structural diagram illustrating another digital item transfer interaction processing device according to one or more implementations of the present specification.

### DESCRIPTION OF IMPLEMENTATIONS

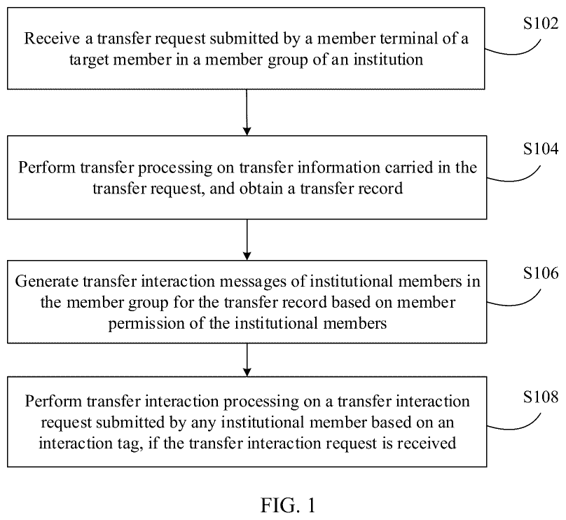

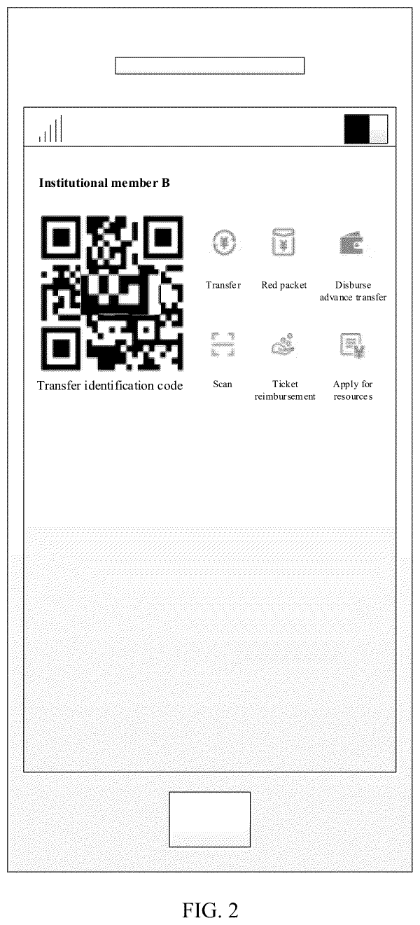

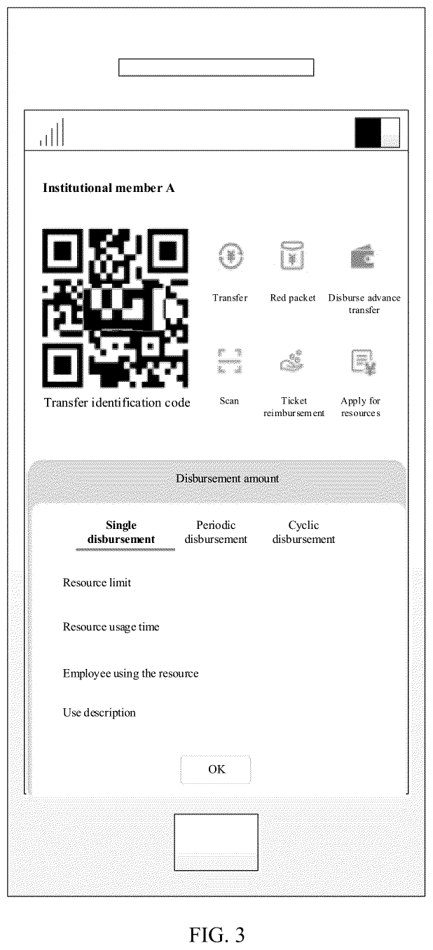

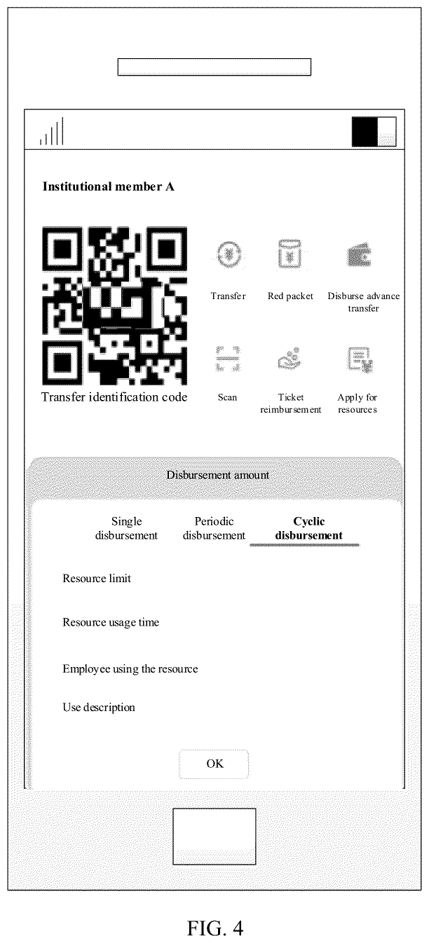

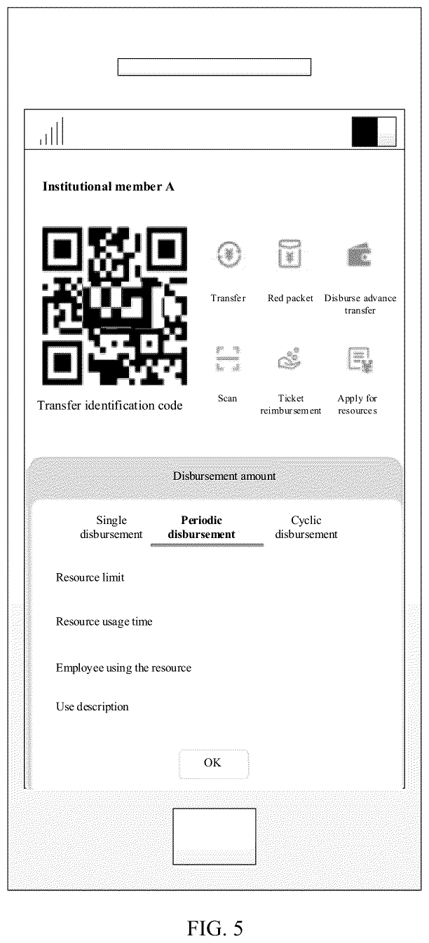

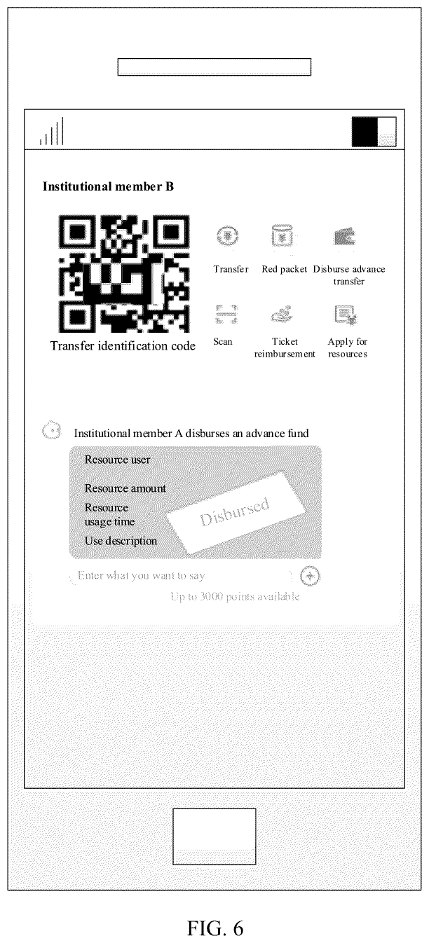

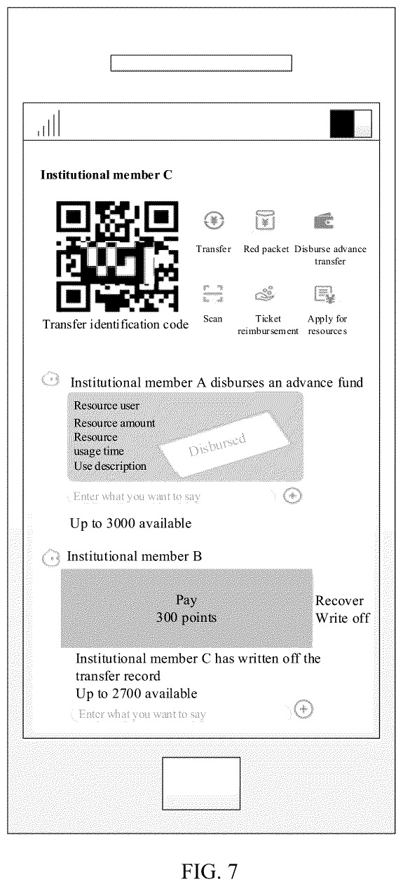

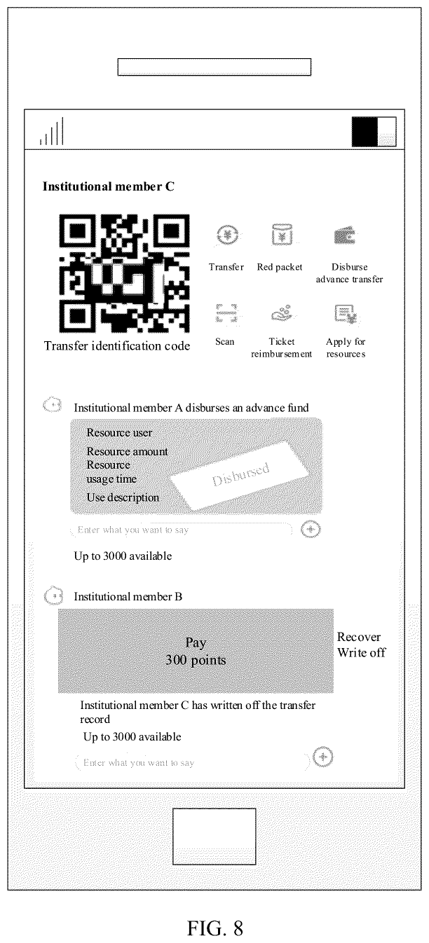

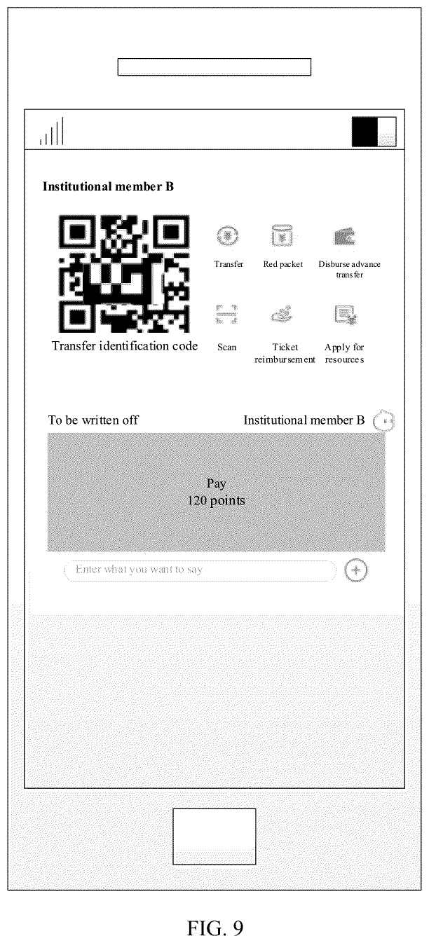

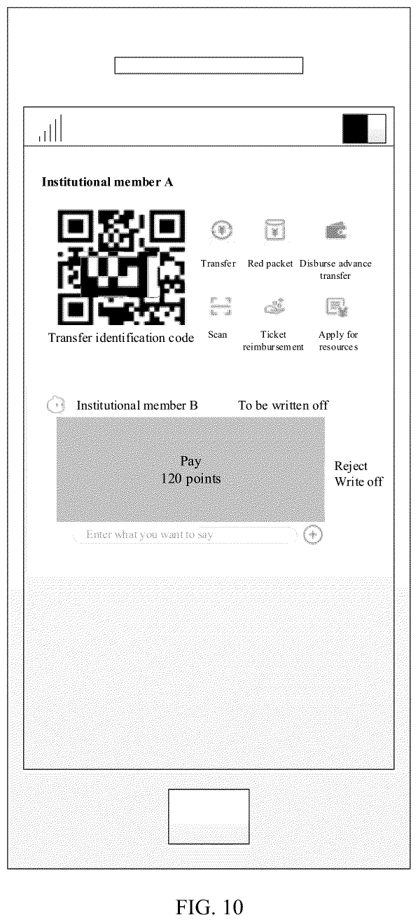

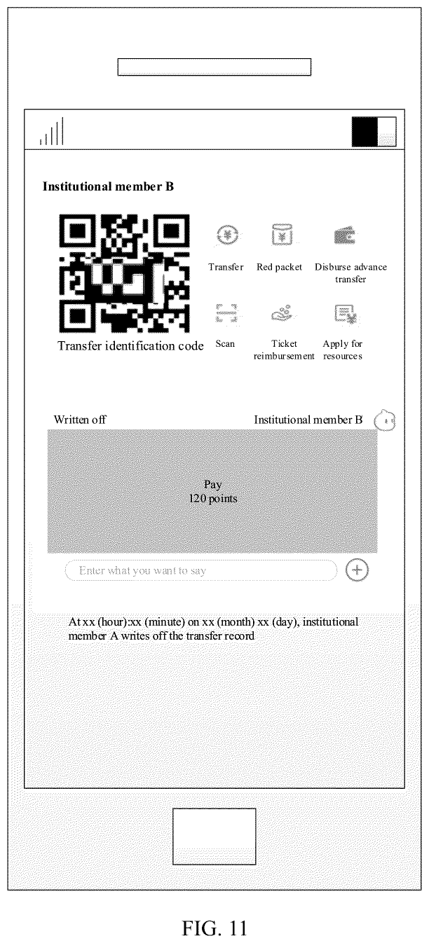

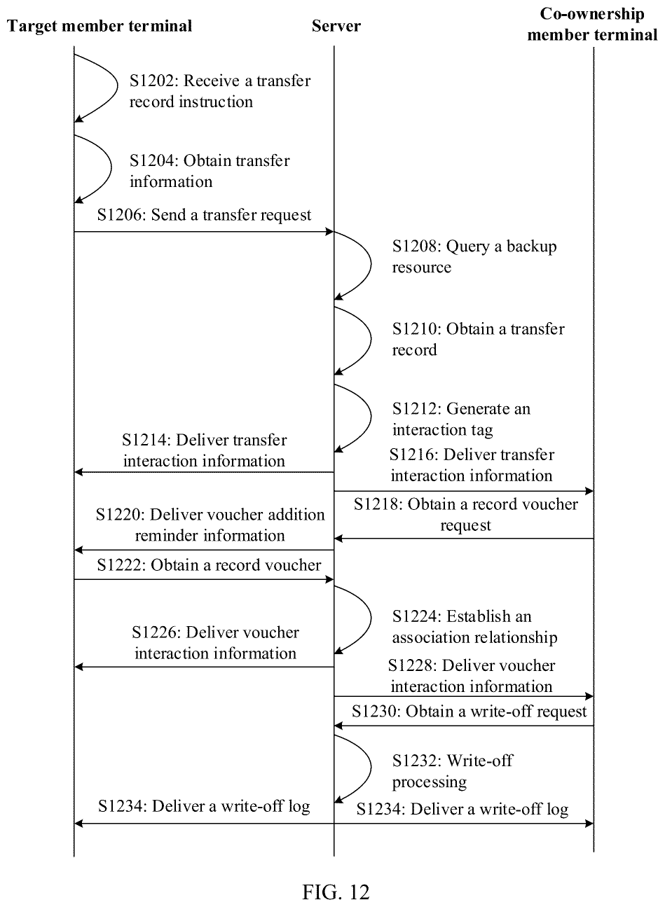

The present specification provides an implementation of a digital item transfer interaction processing method. FIG. 1 is a processing flowchart illustrating a digital item transfer interaction processing method according to the present implementation, FIG. 2 is a schematic diagram illustrating an access page according to the present implementation, FIG. 3 is a schematic diagram illustrating a single backup resource configuration page according to the present implementation, FIG. 4 is a schematic diagram illustrating a cyclic backup resource configuration page according to the present implementation, FIG. 5 is a schematic diagram illustrating a periodic backup resource configuration page according to the present implementation, FIG. 6 is a schematic diagram illustrating a first resource display page according to the present implementation, FIG. 7 is a schematic diagram illustrating a second resource display page according to the present implementation, FIG. 8 is a schematic diagram illustrating a third resource display page according to the present implementation, FIG. 9 is a schematic diagram illustrating an interaction list page according to the present implementation, FIG. 10 is a schematic diagram illustrating another interaction list page according to the present implementation, FIG. 11 is a schematic diagram illustrating a log recording page according to the present implementation, and FIG. 12 is a processing flowchart illustrating a digital item transfer interaction processing method applied to a write-off interaction scenario according to the present implementation.

Referring to FIG. 1, the digital item transfer interaction processing method provided in the present implementation, for example, includes step S102 to step S108.

Step S102: Receive a digital item transfer request submitted by a member terminal of a target member in a member group of an institution.

The digital item transfer interaction processing method provided in the present implementation is applied to a server. After digital item transfer processing is performed on the digital item transfer request submitted by the member terminal of the target member in the member group, a digital item transfer record is obtained, and a digital item transfer interaction message for the digital item transfer record is sent to each institutional member in the member group, so that any institutional member can submit a digital item transfer interaction request for the digital item transfer record. In this way, joint supervision of the digital item transfer record by institutional members in the member group is implemented, and perception of a digital item transfer record of any institutional member in the member group by the institutional members in the member group is improved. A digital item may be any digital information or token that reflects or represent a virtual or physical resource, e.g., products, data resources, services, computing capacities, tangible or non-tangible currencies, etc.

The member group in the present implementation includes a user group that binds at least two users together, a digital item transfer group that jointly supervises a digital item transfer process, or a record group that jointly manages records in a group. The member group is a group in which members of an enterprise or a (temporary) institution jointly participate. For example, nature of the member group is not limited in the present implementation. The digital item transfer request is generated after a digital item transfer interface configured for the member group is triggered. The digital item transfer request includes a digital item transfer request of a red packet type and/or a digital item transfer request of a transfer type.

In example implementations, the target member submits a digital item transfer instruction to the server by using the member terminal. For example, the member terminal receives a digital item transfer instruction submitted by the target member in the member group by triggering the digital item transfer interface of the member group, and then obtains, based on the digital item transfer instruction, digital item transfer information collected for the digital item transfer instruction, generates a digital item transfer request, and submits the digital item transfer request to the server.

In the present implementation, in a process of submitting the digital item transfer instruction, the member terminal obtains an access request of the target member for the member group, and displays an access page based on the access request; and receives a digital item transfer instruction submitted by the target member by triggering an identification code collection component configured on the access page; and after receiving the digital item transfer instruction, invokes the configured collection component to collect a collection identification code, and parses the collection identification code; and interacts with the target member based on a parsing result to obtain the digital item transfer information, generates a digital item transfer request that includes the digital item transfer information, and submits the digital item transfer request to the server.

As shown in FIG. 2, when the target member accesses the member group by using the member terminal, the member terminal displays an access page shown in FIG. 2, where a digital item transfer identification code, an identification code collection component “scan”, a red packet component, a transfer component, a “disburse backup resource (disburse advance digital item transfer)” component, a ticket write-off component, and a resource application (“apply for funds”) component are configured on the access page. After the target member triggers the identification code collection component, the member terminal invokes a configured camera component to collect a collection identification code of a merchant, and after obtaining a digital item transfer resource amount entered by the target member, submits a digital item transfer request that carries a collection account identifier and the digital item transfer resource amount to the server.

In addition, “the receiving the digital item transfer request submitted by the member terminal of the target member in the member group of the institution” can be replaced with “receiving a digital item transfer request submitted after a merchant terminal scans a digital item transfer code identifier of the target member in the member group of the institution”.

Step S104: Perform digital item transfer processing on digital item transfer information carried in the digital item transfer request, and obtain a digital item transfer record.

The digital item transfer information includes an information set that needs to be used in a digital item transfer process. In example implementations, after the digital item transfer request submitted by the member terminal is received, digital item transfer processing is performed on the digital item transfer information carried in the digital item transfer request, and the digital item transfer record is obtained.

To improve perception of a service corresponding to the member group by the institutional member in the member group, any institutional member in the member group can allocate a backup resource to the member group, so that the institutional member in the member group can perform digital item transfer processing based on an account that provides the backup resource. To avoid resource occupation of a resource provider that is caused because the backup resource is frozen due to transfer of the backup resource to a designated account, in the present implementation, when any institutional member allocates a backup resource to the member group, only a backup resource amount allocated by the any institutional member is marked, and a resource in a resource account of the institutional member is not transferred or frozen. In an implementation provided in the present implementation, resource allocation information of the member group is determined in the following manner: obtaining a backup resource allocation request of any target institutional member in the member group for the member group; collecting, based on the backup resource allocation request, a backup update type configured by the target institutional member; collecting a backup resource parameter uploaded by the target institutional member in the backup update type; and determining, based on the backup update type and the backup resource parameter, backup resource information allocated to the member group.

For example, to improve effectiveness of managing the backup resource information, when the backup resource allocation request of the any target institutional member for the member group is obtained, the backup update type configured by the target institutional member is first obtained; then the backup resource parameter uploaded by the target institutional member in the configured backup update type is obtained; and finally, the backup resource information that includes the backup update type and the backup resource parameter is generated.

The backup update type includes a first update type of a single disbursement type, where in the first update type, a fund provider provides a user with a backup resource amount that can be used when a backup digital item transfer condition is satisfied, and the amount is decreased in real time after being used and is not restored; further includes a second update type of a periodic update type, where in the second update type, a fund provider provides a user with a backup resource amount that can be used when a backup digital item transfer condition is satisfied, the amount is decreased in real time after being used, and the backup resource amount is restored in real time after a write-off instruction for the digital item transfer record is obtained; and further includes a third update type of a cyclic update type, where in the third update type, a fund provider provides a user with a backup resource amount that can be used when a backup digital item transfer condition is satisfied, the amount is decreased in real time after being used, and the backup resource amount is restored on the first day of a next cycle after a write-off instruction for the digital item transfer record is obtained.

In some implementations, an available resource amount in the backup resource information is configured based on the backup update type included in the backup resource information; and if the backup update type is the first update type, the available resource amount in the backup resource information remains unchanged.

In an implementation provided in the present implementation, if the backup update type is the second update type, the following operations are performed: obtaining an update cycle condition included in the backup resource information; calculating an update time for the available resource amount based on a digital item transfer time recorded in the digital item transfer record and the update cycle condition; and when it is detected that the update time arrives, updating the available resource amount in the backup resource information to a backup resource amount.

As shown in FIG. 3, institutional member A configures backup resource information for the member group by using a single backup resource configuration page. As shown in FIG. 4, institutional member A configures backup resource information for the member group by using a cyclic backup resource configuration page. As shown in FIG. 5, institutional member A configures backup resource information for the member group by using a periodic backup resource configuration page. After the institutional member configures a backup resource, the backup resource information is displayed by using an interaction list of the member group. As shown in FIG. 6, after institutional member A configures a single backup resource, a first resource display page is displayed. As shown in FIG. 7, after institutional member A configures a periodic backup resource of 3000, institutional member B uses 300 points, and after institutional member C writes off a digital item transfer record of the 300 points for institutional member B, a second resource display page is displayed. As shown in FIG. 8, after institutional member A configures a cyclic backup resource, institutional member B uses 300 points, and after institutional member C writes off a digital item transfer record of the 300 points for institutional member B, a third resource display page is displayed.

In example implementations, when the backup resource information is configured for the member group, digital item transfer processing is performed on the digital item transfer information based on the backup resource information during digital item transfer processing; or when no backup resource information is configured, digital item transfer processing is performed on the digital item transfer information based on a resource account of the target member. To improve perception of the digital item transfer process by the target member, in an implementation provided in the present implementation, in a process of performing digital item transfer processing on the digital item transfer information carried in the digital item transfer request, and obtaining the digital item transfer record, the following operations are performed: querying whether a backup resource is allocated to the member group; and if no backup resource is allocated, performing digital item transfer processing on the digital item transfer information based on the resource account of the target member, and obtaining the digital item transfer record; or if a backup resource is allocated, when the digital item transfer information satisfies a backup digital item transfer condition corresponding to the backup resource information, performing digital item transfer processing on the digital item transfer information based on a resource account corresponding to the backup resource information, and obtaining the digital item transfer record; and updating the backup resource amount in the backup resource information to the available resource amount based on a digital item transfer resource amount included in the digital item transfer information.

In some implementations, the backup digital item transfer condition includes at least one of the following: the digital item transfer resource amount included in the digital item transfer information is less than or equal to the backup resource amount, a member identifier of the target member is recorded in an available member list configured in the backup resource information, or a digital item transfer time recorded in the digital item transfer information falls within an available time range in the backup resource information.

For example, it is queried whether a backup resource is allocated to the member group; and if no backup resource is allocated, digital item transfer processing is performed on the digital item transfer information based on a resource account corresponding to a collection identification code, and the digital item transfer record is obtained; or if a backup resource is allocated, it is first verified whether the digital item transfer information satisfies the backup digital item transfer condition corresponding to the backup resource information; and if the digital item transfer information does not satisfy the backup digital item transfer condition corresponding to the backup resource information, it is determined that digital item transfer fails; or if the digital item transfer information satisfies the backup digital item transfer condition corresponding to the backup resource information, the resource account (that is, a resource account of a backup resource provider) corresponding to the backup resource information is determined, and then digital item transfer processing is performed on the digital item transfer information based on the resource account, and the digital item transfer record is obtained.

Step S106: Generate digital item transfer interaction messages of institutional members in the member group for the digital item transfer record based on member permission of the institutional members.

The digital item transfer interaction messages carry interaction tags of the corresponding institutional members. In the member group, the target member has access permission for the digital item transfer record, and an institutional member other than the target member in the member group has co-ownership permission for the digital item transfer record. To ensure, for the digital item transfer record, an equal co-ownership relationship between co-ownership users that have co-ownership permission for the digital item transfer record, interaction tags of the co-ownership users are consistent. The interaction tag is a tag representing member permission of the institutional member for the digital item transfer record, and is an interaction tag that is determined by the server and that is of the target member for the digital item transfer record obtained after digital item transfer processing is performed on the digital item transfer information. In some implementations, the interaction tag of the target member is empty or a voucher submission tag; and an interaction tag of the institutional member other than the target member in the member group includes a record confirmation tag, a record return tag, and/or a voucher request tag.

In some implementations provided in the present implementation, in a process of generating the digital item transfer interaction messages of the institutional members in the member group for the digital item transfer record based on the member permission of the institutional members, the following operations are performed: determining, based on a digital item transfer type corresponding to the digital item transfer request, a co-ownership member that has co-ownership permission for the digital item transfer record in the institutional members; and generating a review tag of the co-ownership member for the digital item transfer record based on the co-ownership permission, and generating a digital item transfer interaction message that includes the review tag.

In addition, for the target member, a resource addition tag for the digital item transfer record is generated based on the access permission for the digital item transfer record, and a digital item transfer interaction message that includes the resource addition tag is generated. The member terminal of the target member receives a digital item transfer interaction message that is delivered by the server and that carries the interaction tag of the target member, and displays the digital item transfer interaction message in the interaction list of the member group.

Descriptions of the interaction tag in the present implementation are merely examples. In an actual scenario, the interaction tag can be determined based on a requirement. This is not limited in the present implementation.

For example, after institutional member B performs digital item transfer processing by using a resource account of institutional member B and generates a digital item transfer record, institutional member B can perceive a digital item transfer interaction message for the digital item transfer record by using an interaction list page shown in FIG. 9, where a configured real-time location, a communication box, and an entry for uploading a photo/video/invoice are interaction tags of institutional member B for the digital item transfer record.

Institutional member A can perceive a digital item transfer interaction message for the digital item transfer record by using an interaction list page shown in FIG. 10, where a configured real-time location, a communication box, an entry for uploading a photo/video/invoice, a write-off control, and a reject control are interaction tags of institutional member A for the digital item transfer record. A digital item transfer interaction message of another institutional member in the member group is similar to that in FIG. 10. In addition, to improve perception of a write-off status of the digital item transfer record by the group member, the write-off status is further displayed.

Step S108: Perform digital item transfer interaction processing on a digital item transfer interaction request submitted by any institutional member based on an interaction tag, if the digital

In example implementations, there is different digital item transfer interaction processing when digital item transfer is performed by using the backup resource and digital item transfer is performed by using the resource account of the target member.

### (1) Digital Item Transfer Processing Performed Based on the Resource Account of the Target Member

In some implementations provided in the present implementation, after digital item transfer processing is performed based on the resource account of the target member, digital item transfer interaction processing is performed in the following manner: if a write-off request for the digital item transfer record submitted by any target institutional member other than the target member in the member group is received, determining a resource account of the any target institutional member; transferring a resource corresponding to a digital item transfer resource amount recorded in the digital item transfer information in the resource account to a digital item transfer account of the target member; and generating a write-off log for the digital item transfer record based on a resource transfer result and a member identifier of the any target institutional member, and pushing the write-off log to display the write-off log in the interaction list of the member group.

For example, if digital item transfer processing is performed based on the resource account of the target member, another group member in the member group needs to write off the digital item transfer record. After any institutional member other than the target member in the member group submits a write-off request for the digital item transfer record, a resource corresponding to the digital item transfer record is transferred from a resource account of the institutional member to the resource account of the target member, to write off the digital item transfer record.

To improve perception of the write-off status of the digital item transfer record by the institutional member in the member group, the write-off log of the digital item transfer record is generated after write-off for display.

As shown in FIG. 11, after institutional member A writes off the digital item transfer record of institutional member B, a log recording page of “At xx (hour):xx (minute) on xx (month) xx (day), institutional member A writes off the digital item transfer record” is displayed, and a write-off status is updated to “written off”.

### (2) Digital Item Transfer Processing Performed Based on the Backup Resource

In some implementations provided in the present implementation, after digital item transfer processing is performed based on the backup resource information, digital item transfer interaction processing is performed in the following manner: when the backup update type is the cyclic update type, if a confirmation request for the digital item transfer record is received from an institutional member other than the target member in the member group, updating the available resource amount in the backup resource information to the backup resource amount based on the confirmation request.

In addition, when the backup update type is the periodic update type, if a confirmation request for the digital item transfer record is received from an institutional member other than the target member in the member group, obtaining an update cycle condition included in the backup resource information; calculating an update time for the available resource amount based on a digital item transfer time recorded in the digital item transfer record and the update cycle condition; and when it is detected that the update time arrives, updating the available resource amount in the backup resource information to the backup resource amount.

To ensure the authenticity of the digital item transfer record, the institutional member can make voucher requirements for the authenticity and properness of the digital item transfer record, and the target member uploads record vouchers such as an invoice and a video. Based on this, in some implementations provided in the present implementation, digital item transfer interaction processing is performed in the following manner: if a record voucher request for the digital item transfer record submitted by any target institutional member other than the target member in the member group is received, generating voucher addition reminder information based on a voucher type carried in the record voucher request, and pushing the information; obtaining a record voucher uploaded by the target member based on the voucher addition reminder information, and associating the record voucher with the digital item transfer record; and pushing the record voucher to display the record voucher in the interaction list of the member group.

For example, to improve convenience of viewing the record voucher by the institutional member, if the record voucher is of a video type, the video is automatically played, so that one-screen review can be implemented to complete review.

The digital item transfer interaction processing method provided in the present implementation is further described below by using an example in which the digital item transfer interaction processing method provided in the present implementation is applied to a write-off interaction scenario. Referring to FIG. 12, the digital item transfer interaction processing method applied to the write-off interaction scenario, for example, includes the following steps.

Step S1208: After receiving a digital item transfer request, a server queries a backup resource allocated to a member group.

Before this, a target member terminal of a target member receives a digital item transfer instruction submitted by the target member by triggering a collection identification code collection control of the member group, collects a collection identification code, determines digital item transfer information, generates a digital item transfer request based on the digital item transfer information, and sends the digital item transfer request to the server.

Step S1210: If the backup resource is empty, perform digital item transfer processing based on a resource account of the target member, and obtain a digital item transfer record.

Step S1212: Generate an access interaction tag of the target member for the digital item transfer record based on access permission of the target member for the digital item transfer record, and generate a co-ownership interaction tag of a co-ownership account for the digital item transfer record based on co-ownership permission of an institutional member other than the target member in the member group for the digital item transfer record.

Step S1214: Generate a digital item transfer interaction message of the target member for the digital item transfer record based on the access interaction tag, and deliver the digital item transfer interaction message to the target member terminal.

Step S1216: Generate a digital item transfer interaction message of the co-ownership member for the digital item transfer record based on the co-ownership interaction tag, and deliver the digital item transfer interaction message to a co-ownership member terminal.

An execution sequence of step S1214 and step S1216 is not limited in an execution process.

Step S1218: Obtain a record voucher request submitted by the co-ownership member terminal based on a voucher request tag in the co-ownership interaction tag.

Step S1220: Generate voucher addition reminder information based on the record voucher request, and deliver the voucher addition reminder information to the target member terminal.

Step S1222: Obtain a record voucher collected and uploaded by the target member terminal.

Step S1224: Establish an association relationship between the record voucher and the digital item transfer record.

Step S1226: Generate voucher interaction information of the target member for the record voucher based on the access interaction tag, and deliver the voucher interaction information to the target member terminal

Step S1228: Generate voucher interaction information of the co-ownership member for the record voucher based on the co-ownership interaction tag, and deliver the voucher interaction information to the co-ownership member terminal.

Step S1230: Obtain a write-off request submitted by the co-ownership member terminal for the digital item transfer record.

Step S1232: Transfer a resource corresponding to the digital item transfer information in a resource account of the co-ownership member to the resource account of the target member.

Step S1234: Generate a write-off log based on resource transfer, and push the write-off log to the target member terminal and the co-ownership member terminal.

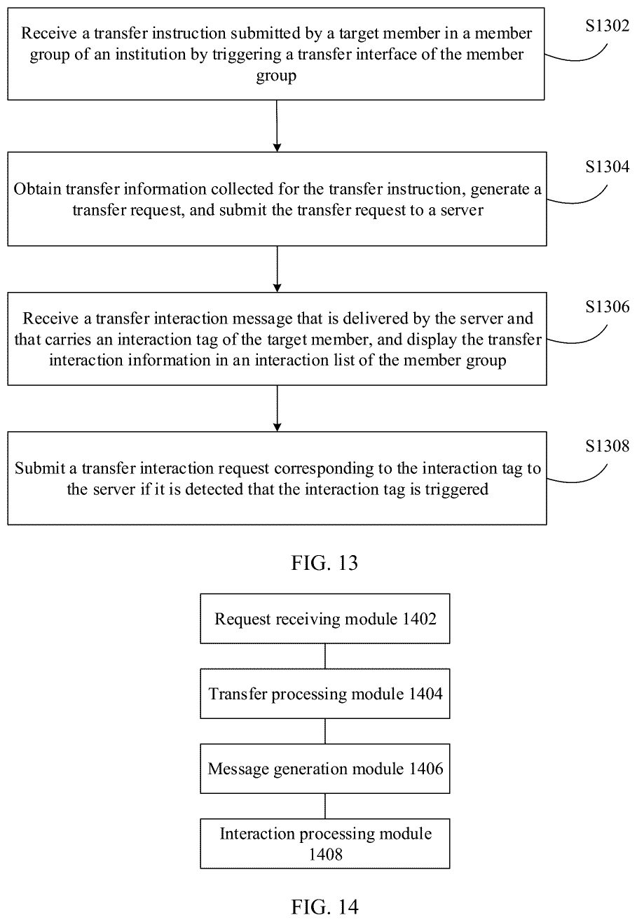

The present specification provides an implementation of another digital item transfer interaction processing method. FIG. 13 is a processing flowchart illustrating a digital item transfer interaction processing method according to the present implementation, FIG. 2 is a schematic diagram illustrating an access page according to the present implementation, FIG. 3 is a schematic diagram illustrating a single backup resource configuration page according to the present implementation, FIG. 4 is a schematic diagram illustrating a cyclic backup resource configuration page according to the present implementation, FIG. 5 is a schematic diagram illustrating a periodic backup resource configuration page according to the present implementation, FIG. 6 is a schematic diagram illustrating a first resource display page according to the present implementation, FIG. 7 is a schematic diagram illustrating a second resource display page according to the present implementation, FIG. 8 is a schematic diagram illustrating a third resource display page according to the present implementation, FIG. 9 is a schematic diagram illustrating an interaction list page according to the present implementation, FIG. 10 is a schematic diagram illustrating another interaction list page according to the present implementation, FIG. 11 is a schematic diagram illustrating a log recording page according to the present implementation, and FIG. 12 is a processing flowchart illustrating a digital item transfer interaction processing method applied to a write-off interaction scenario according to the present implementation.

The digital item transfer interaction processing method provided in the present implementation is applied to a member terminal of a target member. The digital item transfer interaction processing method provided in the present implementation and the digital item transfer interaction processing method applied to the server provided in the above implementation cooperate with each other during running. Therefore, during reading of the present implementation, references can be made to related content of the above implementation.

Referring to FIG. 13, the digital item transfer interaction processing method provided in the present implementation, for example, includes step S1302 to step S1308.

Step S1302: Receive a digital item transfer instruction submitted by a target member in a member group of an institution by triggering a digital item transfer interface of the member group.

The digital item transfer interaction processing method provided in the present implementation is applied to a user terminal of the target member. A digital item transfer request is uploaded to a server, so that the server generates a digital item transfer interaction message that carries an interaction tag, and delivers the digital item transfer interaction message. The digital item transfer interaction message is displayed in an interaction list of the member group when being obtained, and a digital item transfer interaction request corresponding to the interaction tag is submitted to the server when it is detected that the interaction tag is triggered. In this way, the digital item transfer interaction message is displayed in a form of the member group and in a form of the interaction list, to improve perception of the digital item transfer interaction message, and the interaction tag is set to improve convenience of digital item transfer interaction by the target member.

The member group in the present implementation includes a user group that binds at least two users together, a digital item transfer group that jointly supervises a digital item transfer process, or a record group that jointly manages records in a group. The member group is a group in which members of an enterprise or a (temporary) institution jointly participate. For example, nature of the member group is not limited in the present implementation. The digital item transfer request is generated after the digital item transfer interface configured for the member group is triggered. The digital item transfer request includes a digital item transfer request of a red packet type and/or a digital item transfer request of a transfer type.

In example implementations, the target member submits the digital item transfer instruction to the server by using the member terminal. For example, the member terminal receives a digital item transfer instruction submitted by the target member in the member group by triggering the digital item transfer interface of the member group, and then obtains, based on the digital item transfer instruction, digital item transfer information collected for the digital item transfer instruction, generates a digital item transfer request, and submits the digital item transfer request to the server.

In some implementations provided in the present implementation, in a process of submitting the digital item transfer instruction, the member terminal performs the following operations: obtaining an access request of the target member for the member group, and displays an access page based on the access request; and receiving a digital item transfer instruction submitted by the target member by triggering an identification code collection component configured on the access page.

Step S1304: Obtain digital item transfer information collected for the digital item transfer instruction, generate a digital item transfer request, and submit the digital item transfer request to the server.

In some implementations provided in the present implementation, after the digital item transfer instruction is obtained, the digital item transfer information is obtained, the digital item transfer request is generated, and the digital item transfer request is submitted to the server, in the following manner: invoking the configured collection component to collect a collection identification code, and parsing the collection identification code; and interacting with the target member based on a parsing result to obtain the digital item transfer information, generating a digital item transfer request that includes the digital item transfer information, and submitting the digital item transfer request to the server.

As shown in FIG. 2, when the target member accesses the member group by using the member terminal, the member terminal displays an access page shown in FIG. 2, where a digital item transfer identification code, an identification code collection component 201, a red packet component 202, a transfer component 203, a “disburse backup resource” component 204, a ticket write-off component 205, and a resource application component 206 are configured on the access page. After the target member triggers the identification code collection component 201, the member terminal invokes a configured camera component to collect a collection identification code of a merchant, and after obtaining a digital item transfer resource amount entered by the target member, submits a digital item transfer request that carries a collection account identifier and the digital item transfer resource amount to the server.

In some implementations provided in the present implementation, after receiving the digital item transfer request, the server performs the following operations: performing digital item transfer processing on the digital item transfer information carried in the digital item transfer request, and generating a digital item transfer record; determining an interaction tag of the target member for the digital item transfer record based on member permission of the target member for the digital item transfer record; and generating access information of the target member for the digital item transfer record based on the interaction tag, generating the digital item transfer interaction message that includes the access information, and delivering the digital item transfer interaction message to the member terminal of the target member.

For example, the following describes in detail a process of generating the digital item transfer record and the digital item transfer interaction message by the server.

The digital item transfer information includes an information set that needs to be used in a digital item transfer process. In example implementations, after the digital item transfer request submitted by the member terminal is received, digital item transfer processing is performed on the digital item transfer information carried in the digital item transfer request, and the digital item transfer record is obtained.

To improve perception of a service corresponding to the member group by the institutional member in the member group, any institutional member in the member group can allocate a backup resource to the member group, so that the institutional member in the member group can perform digital item transfer processing based on an account that provides the backup resource. To avoid resource occupation of a resource provider that is caused because the backup resource is frozen due to transfer of the backup resource to a designated account, in the present implementation, when any institutional member allocates a backup resource to the member group, only a backup resource amount allocated by the any institutional member is marked, and a resource in a resource account of the institutional member is not transferred or frozen. In some implementations provided in the present implementation, resource allocation information of the member group is determined in the following manner: obtaining a backup resource allocation request of any target institutional member in the member group for the member group; collecting, based on the backup resource allocation request, a backup update type configured by the target institutional member; collecting a backup resource parameter uploaded by the target institutional member in the backup update type; and determining, based on the backup update type and the backup resource parameter, backup resource information allocated to the member group.

For example, to improve effectiveness of managing the backup resource information, when the backup resource allocation request of the any target institutional member for the member group is obtained, the backup update type configured by the target institutional member is first obtained; then the backup resource parameter uploaded by the target institutional member in the configured backup update type is obtained; and finally, the backup resource information that includes the backup update type and the backup resource parameter is generated.

The backup update type includes a first update type of a single disbursement type, where in the first update type, a fund provider provides a user with a backup resource amount that can be used when a backup digital item transfer condition is satisfied, and the amount is decreased in real time after being used and is not restored; further includes a second update type of a periodic update type, where in the second update type, a fund provider provides a user with a backup resource amount that can be used when a backup digital item transfer condition is satisfied, the amount is decreased in real time after being used, and the backup resource amount is restored in real time after a write-off instruction for the digital item transfer record is obtained; and further includes a third update type of a cyclic update type, where in the third update type, a fund provider provides a user with a backup resource amount that can be used when a backup digital item transfer condition is satisfied, the amount is decreased in real time after being used, and the backup resource amount is restored on the first day of a next cycle after a write-off instruction for the digital item transfer record is obtained.

In some implementations, an available resource amount in the backup resource information is configured based on the backup update type included in the backup resource information; and if the backup update type is the first update type, the available resource amount in the backup resource information remains unchanged.

In some implementations provided in the present implementation, if the backup update type is the second update type, the following operations are performed: obtaining an update cycle condition included in the backup resource information; calculating an update time for the available resource amount based on a digital item transfer time recorded in the digital item transfer record and the update cycle condition; and when it is detected that the update time arrives, updating the available resource amount in the backup resource information to a backup resource amount.

As shown in FIG. 3, institutional member A configures backup resource information for the member group by using a single backup resource configuration page. As shown in FIG. 4, institutional member A configures backup resource information for the member group by using a cyclic backup resource configuration page. As shown in FIG. 5, institutional member A configures backup resource information for the member group by using a periodic backup resource configuration page. After the institutional member configures a backup resource, the backup resource information is displayed by using the interaction list of the member group. As shown in FIG. 6, after institutional member A configures a single backup resource, a first resource display page is displayed. As shown in FIG. 7, after institutional member A configures a periodic backup resource, institutional member B uses 300 points, and after institutional member C writes off a digital item transfer record of the 300 points for institutional member B, a second resource display page is displayed. As shown in FIG. 8, after institutional member A configures a cyclic backup resource, institutional member B uses 300 points, and after institutional member C writes off a digital item transfer record of the 300 points for institutional member B, a third resource display page is displayed.

In example implementations, when the backup resource information is configured for the member group, digital item transfer processing is performed on the digital item transfer information based on the backup resource information during digital item transfer processing; or when no backup resource information is configured, digital item transfer processing is performed on the digital item transfer information based on a resource account of the target member. To improve perception of the digital item transfer process by the target member, in some implementations provided in the present implementation, in a process of performing digital item transfer processing on the digital item transfer information carried in the digital item transfer request, and obtaining the digital item transfer record, the following operations are performed: querying whether a backup resource is allocated to the member group; and if no backup resource is allocated, performing digital item transfer processing on the digital item transfer information based on the resource account of the target member, and obtaining the digital item transfer record; or if a backup resource is allocated, when the digital item transfer information satisfies a backup digital item transfer condition corresponding to the backup resource information, performing digital item transfer processing on the digital item transfer information based on a resource account corresponding to the backup resource information, and obtaining the digital item transfer record; and updating the backup resource amount in the backup resource information to the available resource amount based on a digital item transfer resource amount included in the digital item transfer information.

In some implementations, the backup digital item transfer condition includes at least one of the following: the digital item transfer resource amount included in the digital item transfer information is less than or equal to the backup resource amount, a member identifier of the target member is recorded in an available member list configured in the backup resource information, or a digital item transfer time recorded in the digital item transfer information falls within an available time range in the backup resource information.

For example, it is queried whether a backup resource is allocated to the member group; and if no backup resource is allocated, digital item transfer processing is performed on the digital item transfer information based on a resource account corresponding to a collection identification code, and the digital item transfer record is obtained; or if a backup resource is allocated, it is first verified whether the digital item transfer information satisfies the backup digital item transfer condition corresponding to the backup resource information; and if the digital item transfer information does not satisfy the backup digital item transfer condition corresponding to the backup resource information, it is determined that digital item transfer fails; or if the digital item transfer information satisfies the backup digital item transfer condition corresponding to the backup resource information, the resource account (that is, a resource account of a backup resource provider) corresponding to the backup resource information is determined, and then digital item transfer processing is performed on the digital item transfer information based on the resource account, and the digital item transfer record is obtained.

Digital item transfer interaction messages of institutional members in the member group for the digital item transfer record are generated based on member permission of the institutional members.

The digital item transfer interaction messages carry interaction tags of the corresponding institutional members. In the member group, the target member has access permission for the digital item transfer record, and an institutional member other than the target member in the member group has co-ownership permission for the digital item transfer record. To ensure, for the digital item transfer record, an equal co-ownership relationship between co-ownership users that have co-ownership permission for the digital item transfer record, interaction tags of the co-ownership users are consistent. The interaction tag is a tag representing member permission of the institutional member for the digital item transfer record, and is an interaction tag that is determined by the server and that is of the target member for the digital item transfer record obtained after digital item transfer processing is performed on the digital item transfer information. In some implementations, the interaction tag of the target member is empty or a voucher submission tag; and an interaction tag of the institutional member other than the target member in the member group includes a record confirmation tag, a record return tag, and/or a voucher request tag.

In some implementations provided in the present implementation, in a process of generating the digital item transfer interaction messages of the institutional members in the member group for the digital item transfer record based on the member permission of the institutional members, the following operations are performed: determining, based on a digital item transfer type corresponding to the digital item transfer request, a co-ownership member that has co-ownership permission for the digital item transfer record in the institutional members; and generating a review tag of the co-ownership member for the digital item transfer record based on the co-ownership permission, and generating a digital item transfer interaction message that includes the review tag.

Descriptions of the interaction tag in the present implementation are merely examples. In an actual scenario, the interaction tag can be determined based on a requirement. This is not limited in the present implementation.

For example, after institutional member B performs digital item transfer processing by using a resource account of institutional member B and generates a digital item transfer record, institutional member B can perceive a digital item transfer interaction message for the digital item transfer record by using an interaction list page shown in FIG. 9, where a configured real-time location, a communication box, and an entry for uploading a photo/video/invoice are interaction tags of institutional member B for the digital item transfer record.

Institutional member A can perceive a digital item transfer interaction message for the digital item transfer record by using an interaction list page shown in FIG. 10, where a configured real-time location, a communication box, an entry for uploading a photo/video/invoice, a write-off control, and a reject control are interaction tags of institutional member A for the digital item transfer record. A digital item transfer interaction message of another institutional member in the member group is similar to that in FIG. 10. In addition, to improve perception of a write-off status of the digital item transfer record by the group member, the write-off status is further displayed.

Step S1306: Receive a digital item transfer interaction message that is delivered by the server and that carries the interaction tag of the target member, and display the digital item transfer interaction message in the interaction list of the member group.

For the target member, a resource addition tag for the digital item transfer record is generated based on the access permission for the digital item transfer record, and a digital item transfer interaction message that includes the resource addition tag is generated. The member terminal of the target member receives the digital item transfer interaction message that is delivered by the server and that carries the interaction tag of the target member, and displays the digital item transfer interaction message in the interaction list of the member group.

Descriptions of the interaction tag in the present implementation are merely examples. In an actual scenario, the interaction tag can be determined based on a requirement. This is not limited in the present implementation.

For example, after institutional member B performs digital item transfer processing by using a resource account of institutional member B and generates a digital item transfer record, institutional member B can perceive a digital item transfer interaction message for the digital item transfer record by using an interaction list page shown in FIG. 9, where a configured real-time location, a communication box, and an entry for uploading a photo/video/invoice are interaction tags of institutional member B for the digital item transfer record.

Step S1308: Submit a digital item transfer interaction request corresponding to the interaction tag to the server if it is detected that the interaction tag is triggered.

In some implementations provided in the present implementation, if it is detected that the interaction tag is triggered, a record voucher for the digital item transfer record is collected based on a tag type of the interaction tag; the record voucher is submitted to the server, so that the server associates the record voucher with the digital item transfer record; the record voucher delivered after the server associates the record voucher with the digital item transfer record is obtained; and if the record voucher is of a video type, the record voucher is played when it is detected that the member group is accessed.

For example, the target member can upload the record voucher based on the interaction tag, collect the record voucher when it is detected that the interaction tag is triggered, and upload the record voucher to the server, so that the server associates the record voucher with the digital item transfer record. After associating the record voucher with the digital item transfer record, the server generates an interaction tag for the record voucher based on the access permission of the target member for the digital item transfer record, generates voucher interaction information that carries the interaction tag, and sends the voucher interaction information to the member terminal. After receiving the voucher interaction information, the member terminal displays the voucher interaction information in the interaction list. In addition, after associating the record voucher with the digital item transfer record, the server generates an interaction tag of the co-ownership member for the record voucher based on the co-ownership permission of the co-ownership user for the digital item transfer record, generates voucher interaction information that carries the interaction tag, and sends the voucher interaction information to a member terminal of the co-ownership member.

The digital item transfer interaction processing method provided in the present implementation is further described below by using an example in which the digital item transfer interaction processing method provided in the present implementation is applied to a write-off interaction scenario. Referring to FIG. 12, the digital item transfer interaction processing method applied to the write-off interaction scenario, for example, includes the following steps.

Step S1202: A target member terminal of a target member receives a digital item transfer instruction submitted by the target member by triggering a collection identification code collection control of a member group.

Step S1204: Collect a collection identification code, and obtain digital item transfer information.

Step S1206: Generate a digital item transfer request based on the digital item transfer information, and send the digital item transfer request to a server.

Subsequently, after receiving the digital item transfer request, the server queries a backup resource allocated to the member group; if the backup resource is empty, performs digital item transfer processing based on a resource account of the target member, and obtains a digital item transfer record; generates an access interaction tag of the target member for the digital item transfer record based on access permission of the target member for the digital item transfer record, and generates a co-ownership interaction tag of a co-ownership account for the digital item transfer record based on co-ownership permission of an institutional member other than the target member in the member group for the digital item transfer record; generates a digital item transfer interaction message of the target member for the digital item transfer record based on the access interaction tag, and delivers the digital item transfer interaction message to the target member terminal; generates a digital item transfer interaction message of the co-ownership member for the digital item transfer record based on the co-ownership interaction tag, and delivers the digital item transfer interaction message to a co-ownership member terminal; obtains a record voucher request submitted by the co-ownership member terminal based on a voucher request tag in the co-ownership interaction tag; generates voucher addition reminder information based on the record voucher request, and delivers the voucher addition reminder information to the target member terminal; obtains a record voucher collected and uploaded by the target member terminal; establishes an association relationship between the record voucher and the digital item transfer record; generates voucher interaction information of the target member for the record voucher based on the access interaction tag, and delivers the voucher interaction information to the target member terminal; generates voucher interaction information of the co-ownership member for the record voucher based on the co-ownership interaction tag, and delivers the voucher interaction information to the co-ownership member terminal; obtains a write-off request submitted by the co-ownership member terminal for the digital item transfer record; and transfers a resource corresponding to the digital item transfer information in a resource account of the co-ownership member to the resource account of the target member.

An implementation of a digital item transfer interaction processing apparatus provided in the present specification is as follows: In the above implementation, a digital item transfer interaction processing method is provided. Correspondingly, a digital item transfer interaction processing apparatus is further provided, and is described below with reference to the accompanying drawings.

FIG. 14 is a schematic diagram illustrating a digital item transfer interaction processing apparatus according to an implementation.

The apparatus implementations correspond to the method implementations, and therefore are briefly described. For related parts, references can be made to corresponding descriptions of the method implementations provided above. The apparatus implementations described below are merely examples.

The digital item transfer interaction processing apparatus provided in the present implementation includes: a request receiving module 1402, configured to receive a digital item transfer request submitted by a member terminal of a target member in a member group of an institution, where the digital item transfer request is generated after a digital item transfer interface configured for the member group is triggered; a digital item transfer processing module 1404, configured to: perform digital item transfer processing on digital item transfer information carried in the digital item transfer request, and obtain a digital item transfer record; a message generation module 1406, configured to generate digital item transfer interaction messages of institutional members in the member group for the digital item transfer record based on member permission of the institutional members, where the digital item transfer interaction messages carry interaction tags of the corresponding institutional members; and an interaction processing module 1408 that is run if a digital item transfer interaction request submitted by any institutional member based on an interaction tag is received, where the interaction processing module 1408 is configured to perform digital item transfer interaction processing on the digital item transfer interaction request.

An implementation of another digital item transfer interaction processing apparatus provided in the present specification is as follows: In the above implementation, another digital item transfer interaction processing method is provided. Correspondingly, another digital item transfer interaction processing apparatus is further provided, and is described below with reference to the accompanying drawings.

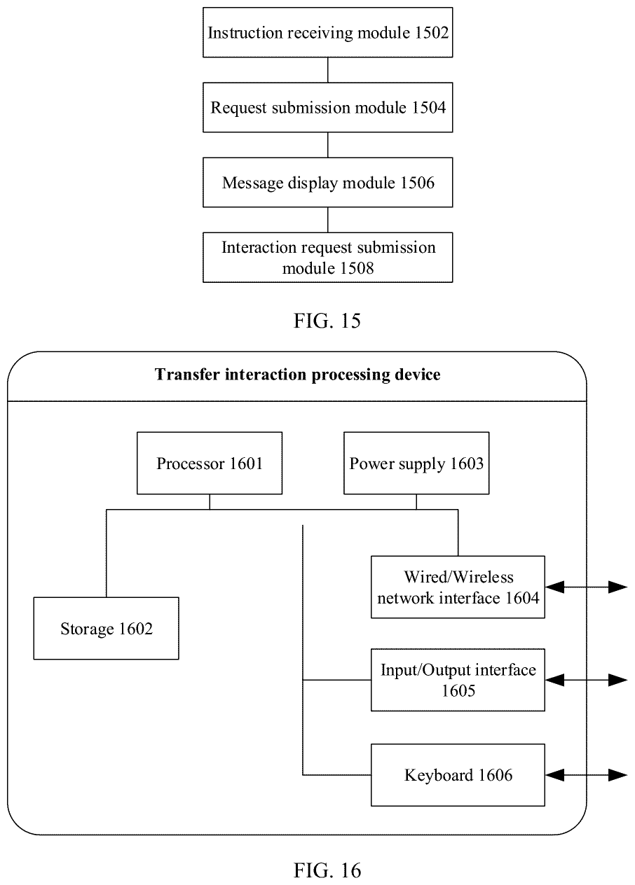

FIG. 15 is a schematic diagram illustrating a digital item transfer interaction processing apparatus according to an implementation. The apparatus implementations correspond to the method implementations. For related parts, references can be made to the above method implementations. The following descriptions are merely examples.

The digital item transfer interaction processing apparatus provided in the present implementation includes: an instruction receiving module 1502, configured to receive a digital item transfer instruction submitted by a target member in a member group of an institution by triggering a digital item transfer interface of the member group; a request submission module 1504, configured to: obtain digital item transfer information collected for the digital item transfer instruction, generate a digital item transfer request, and submit the digital item transfer request to a server; a message display module 1506, configured to: receive a digital item transfer interaction message that is delivered by the server and that carries an interaction tag of the target member, and display the digital item transfer interaction message in an interaction list of the member group; and an interaction request submission module 1508 that is run if it is detected that the interaction tag is triggered, where the interaction request submission module 1508 is configured to submit a digital item transfer interaction request corresponding to the interaction tag to the server.

An implementation of a digital item transfer interaction processing device provided in the present specification is as follows: Corresponding to the digital item transfer interaction processing method described above, based on the same technical concept, one or more implementations of the present specification further provide a digital item transfer interaction processing device. The digital item transfer interaction processing device is configured to perform the digital item transfer interaction processing method provided above. FIG. 16 is a schematic structural diagram illustrating a digital item transfer interaction processing device according to one or more implementations of the present specification.

The digital item transfer interaction processing device provided in the present implementation includes the following: As shown in FIG. 16, the digital item transfer interaction processing device can vary greatly based on configuration or performance, and can include one or more processors 1601 and a storage 1602. The storage 1602 can store one or more storage applications or data. The storage 1602 can be a temporary storage or a persistent storage. The application stored in the storage 1602 can include one or more modules (not shown in the figure), and each module can include a series of computer-executable instructions in the digital item transfer interaction processing device. Further, the processor 1601 can be configured to communicate with the storage 1602, and execute a series of computer-executable instructions in the storage 1602 on the digital item transfer interaction processing device. The digital item transfer interaction processing device can further include one or more power supplies 1603, one or more wired or wireless network interfaces 1604, one or more input/output interfaces 1605, one or more keyboards 1606, etc.

In example implementations, the digital item transfer interaction processing device includes a storage and one or more programs. The one or more programs are stored in the storage. The one or more programs can include one or more modules, and each module can include a series of computer-executable instructions in the digital item transfer interaction processing device. The one or more programs configured to be executed by the one or more processors include computer-executable instructions for performing the following operations: receiving a digital item transfer request submitted by a member terminal of a target member in a member group of an institution, where the digital item transfer request is generated after a digital item transfer interface configured for the member group is triggered; performing digital item transfer processing on digital item transfer information carried in the digital item transfer request, and obtaining a digital item transfer record; generating digital item transfer interaction messages of institutional members in the member group for the digital item transfer record based on member permission of the institutional members, where the digital item transfer interaction messages carry interaction tags of the corresponding institutional members; and performing digital item transfer interaction processing on a digital item transfer interaction request submitted by any institutional member based on an interaction tag, if the digital item transfer interaction request is received.

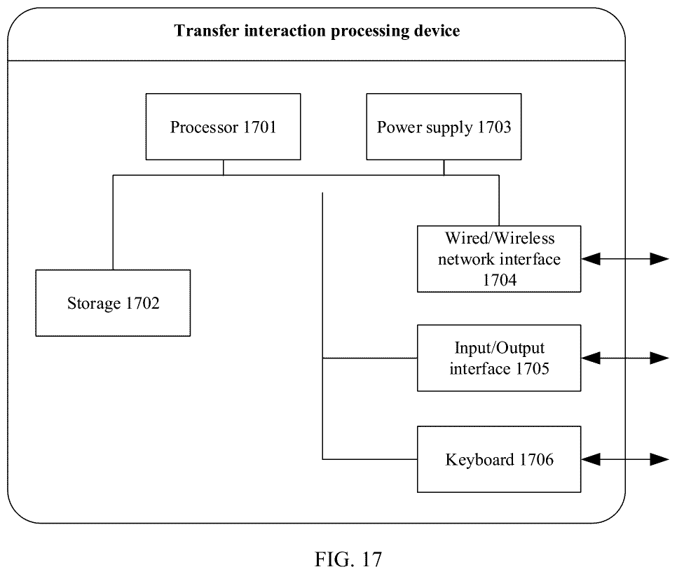

An implementation of another digital item transfer interaction processing device provided in the present specification is as follows: Corresponding to the other digital item transfer interaction processing method described above, based on the same technical concept, one or more implementations of the present specification further provide another digital item transfer interaction processing device. The digital item transfer interaction processing device is configured to perform the digital item transfer interaction processing method provided above. FIG. 17 is a schematic structural diagram illustrating a digital item transfer interaction processing device according to one or more implementations of the present specification.

The digital item transfer interaction processing device provided in the present implementation includes the following: As shown in FIG. 17, the digital item transfer interaction processing device can vary greatly based on configuration or performance, and can include one or more processors 1701 and a storage 1702. The storage 1702 can store one or more storage applications or data. The storage 1702 can be a temporary storage or a persistent storage. The application stored in the storage 1702 can include one or more modules (not shown in the figure), and each module can include a series of computer-executable instructions in the digital item transfer interaction processing device. Further, the processor 1701 can be configured to communicate with the storage 1702, and execute a series of computer-executable instructions in the storage 1702 on the digital item transfer interaction processing device. The digital item transfer interaction processing device can further include one or more power supplies 1703, one or more wired or wireless network interfaces 1704, one or more input/output interfaces 1705, one or more keyboards 1706, etc.

In example implementations, the digital item transfer interaction processing device includes a storage and one or more programs. The one or more programs are stored in the storage. The one or more programs can include one or more modules, and each module can include a series of computer-executable instructions in the digital item transfer interaction processing device. The one or more programs configured to be executed by the one or more processors include computer-executable instructions for performing the following operations: receiving a digital item transfer instruction submitted by a target member in a member group of an institution by triggering a digital item transfer interface of the member group; obtaining digital item transfer information collected for the digital item transfer instruction, generating a digital item transfer request, and submitting the digital item transfer request to a server; receiving a digital item transfer interaction message that is delivered by the server and that carries an interaction tag of the target member, and displaying the digital item transfer interaction message in an interaction list of the member group; and submitting a digital item transfer interaction request corresponding to the interaction tag to the server if it is detected that the interaction tag is triggered.

An implementation of a storage medium provided in the present specification is as follows: Corresponding to the digital item transfer interaction processing method described above, based on the same technical concept, one or more implementations of the present specification further provide a storage medium.

The storage medium provided in the present implementation is configured to store computer-executable instructions. When the computer-executable instructions are executed by a processor, the following procedure is implemented: receiving a digital item transfer request submitted by a member terminal of a target member in a member group of an institution, where the digital item transfer request is generated after a digital item transfer interface configured for the member group is triggered; performing digital item transfer processing on digital item transfer information carried in the digital item transfer request, and obtaining a digital item transfer record; generating digital item transfer interaction messages of institutional members in the member group for the digital item transfer record based on member permission of the institutional members, where the digital item transfer interaction messages carry interaction tags of the corresponding institutional members; and performing digital item transfer interaction processing on a digital item transfer interaction request submitted by any institutional member based on an interaction tag, if the digital item transfer interaction request is received.

The implementation of the storage medium in the present specification and the implementation of the digital item transfer interaction processing method in the present specification are based on the same invention concept. For example implementations, references can be made to the above corresponding method. Details are omitted herein for simplicity.

An implementation of another storage medium provided in the present specification is as follows: Corresponding to the other digital item transfer interaction processing method described above, based on the same technical concept, one or more implementations of the present specification further provide another storage medium.

The storage medium provided in the present implementation is configured to store computer-executable instructions. When the computer-executable instructions are executed by a processor, the following procedure is implemented: receiving a digital item transfer instruction submitted by a target member in a member group of an institution by triggering a digital item transfer interface of the member group; obtaining digital item transfer information collected for the digital item transfer instruction, generating a digital item transfer request, and submitting the digital item transfer request to a server; receiving a digital item transfer interaction message that is delivered by the server and that carries an interaction tag of the target member, and displaying the digital item transfer interaction message in an interaction list of the member group; and submitting a digital item transfer interaction request corresponding to the interaction tag to the server if it is detected that the interaction tag is triggered.

The implementation of the storage medium in the present specification and the implementation of the digital item transfer interaction processing method in the present specification are based on the same invention concept. Therefore, for example implementations of the present implementation, references can be made to the above corresponding method.

Example implementations of the present specification are described above. Other implementations fall within the scope of the appended claims. In some cases, the actions or steps described in the claims can be performed in a sequence different from that in the implementations and desired results can still be achieved. In addition, the process depicted in the accompanying drawings does not necessarily need a particular sequence or a consecutive sequence to achieve the desired results. In some implementations, multi-tasking and parallel processing are feasible or may be advantageous.

In the 1930s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. The designer performs programming to “integrate” a digital system to a PLD without requesting a chip manufacturer to design and produce an application-specific integrated circuit chip. In addition, currently, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). At present, the Very-High-Speed Integrated Circuit Hardware Description Language (VHDL) and Verilog are most commonly used. It should also be clear to a person skilled in the art that a hardware circuit that implements a logical method procedure can be readily obtained once the method procedure is logically programmed by using the several hardware description languages described above and is programmed into an integrated circuit.

A controller can be implemented in any suitable manner, for example, the controller can use a form such as a microprocessor, a processor, or a computer-readable medium, a logic gate, a switch, an application-specific integrated circuit (ASIC), a programmable logic controller, or an embedded microcontroller storing computer-readable program code (such as software or firmware) that can be executed by the (micro) processor. Examples of the controller include but are not limited to the following microcontrollers: ARC 625D, Atmel AT91SAM, Microchip PIC18F26K20, and Silicone Labs C8051F320. A storage controller can also be implemented as a part of control logic of the storage. A person skilled in the art also knows that in addition to implementing the controller by using only the computer-readable program code, logic programming can absolutely be performed on method steps to enable the controller to implement the same function in a form of a logic gate, a switch, an application-specific integrated circuit, a programmable logic controller, or an embedded microcontroller. Therefore, the controller can be considered as a hardware component, and an apparatus configured to implement various functions in the controller can also be considered as a structure in the hardware component. Alternatively or additionally, an apparatus configured to implement various functions can even be considered as both a software module implementing the method and a structure in the hardware component.

The systems, apparatuses, modules, or units described in the above implementations can be, for example, implemented by a computer chip or an entity, or can be implemented by a product having a certain function. A typical implementation device is a computer. For example, the computer can be a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above apparatus is described by dividing functions into various units. Certainly, when the implementations of the present specification are implemented, functions of the units can be implemented in one or more pieces of software and/or hardware.

A person skilled in the art should understand that one or more implementations of the present specification can be provided as methods, systems, or computer program products. Therefore, the one or more implementations of the present specification can use a form of hardware only implementations, software only implementations, or implementations with a combination of software and hardware. In addition, the present specification can use a form of a computer program product that is implemented on one or more computer-usable storage media (including but not limited to a disk storage, a CD-ROM, an optical storage, etc.) that include computer-usable program code.

The present specification is described with reference to the flowcharts and/or block diagrams of the method, the device (system), and the computer program product according to the implementations of the present specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more procedures in the flowcharts and/or in one or more blocks in the block diagrams.

Alternatively or additionally, these computer program instructions can be stored in a computer-readable storage that can instruct a computer or another programmable data processing device to work in a specific manner, so the instructions stored in the computer-readable storage generate an artifact that includes an instruction apparatus. The instruction apparatus implements a specific function in one or more procedures in the flowcharts and/or in one or more blocks in the block diagrams.

Alternatively or additionally, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), one or more input/output interfaces, one or more network interfaces, and one or more memories.

The memory can include a non-persistent memory, a random access memory (RAM), a nonvolatile memory, and/or another form in a computer-readable medium, for example, a read-only memory (ROM) or a flash memory (flash RAM). The memory is an example of the-computer readable medium.

The computer-readable medium includes persistent, non-persistent, removable and non-removable media that can store information by using any method or technology. The information can be computer-readable instructions, a data structure, a program module, or other data. Examples of a computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a magnetic cassette, a magnetic tape/magnetic disk storage or another magnetic storage device, or any other non-transmission medium that can be used to store information that can be accessed by a computing device. As described in the present specification, the computer-readable medium does not include computer-readable transitory media such as a modulated data signal and a carrier.

The terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, an element limited by the statement “includes a . . . ” does not exclude the existence of additional identical elements in the process, method, product, or device that includes the element.

The one or more implementations of the present specification can be described in the general context of computer-executable instructions, for example, a program module. Generally, the program module includes a routine, a program, an object, a component, a data structure, etc. for executing a specific task or implementing a specific abstract data type. Alternatively or additionally, the one or more implementations of the present specification can be practiced in distributed computing environments. In the distributed computing environments, tasks are performed by remote processing devices connected through a communication network. In the distributed computing environments, the program module can be located in a local and remote computer storage medium including a storage device.

The implementations of the present specification are described in a progressive manner. For same or similar parts of the implementations, mutual references can be made to the implementations. Each implementation focuses on a difference from the other implementations. Particularly, the system implementations are basically similar to the method implementations, and therefore are described briefly. For related parts, references can be made to some descriptions of the method implementations.

The above descriptions are merely implementations of the present specification and are not intended to limit the present specification. A person skilled in the art can make various changes and variations to the present specification. Any modification, equivalent replacement, improvement, etc. made without departing from the spirit and principle of the present specification shall fall within the scope of the claims in the present specification.

What is claimed is:

1. A digital item transfer interaction processing method, comprising:
receiving a digital item transfer request submitted by a member terminal of a target member in a member group of an institution, wherein the digital item transfer request is generated after a digital item transfer interface configured for the member group is triggered;
performing digital item transfer processing on digital item transfer information carried in the digital item transfer request, and obtaining a digital item transfer record;
generating digital item transfer interaction messages of institutional members in the member group for the digital item transfer record based on member permission of the institutional members, wherein the digital item transfer interaction messages carry interaction tags of the corresponding institutional members; and
performing digital item transfer interaction processing on a digital item transfer interaction request submitted by an institutional member based on an interaction tag, if the digital item transfer interaction request is received.

2. The method according to claim 1, wherein the performing digital item transfer processing on the digital item transfer information carried in the digital item transfer request includes:
querying whether a backup resource is allocated to the member group; and
in response to no backup resource is allocated, performing digital item transfer processing on the digital item transfer information based on a resource account of the target member.

3. The method according to claim 2, wherein in response to a backup resource is allocated to the member group, performing operations including:
in response to the digital item transfer information satisfies a backup digital item transfer condition corresponding to backup resource information, performing digital item transfer processing on the digital item transfer information based on a resource account corresponding to the backup resource information, and obtaining the digital item transfer record; and
updating a backup resource amount in the backup resource information to an available resource amount based on a digital item transfer resource amount included in the digital item transfer information.

4. The method according to claim 3, wherein the backup digital item transfer condition includes at least one of:
the digital item transfer resource amount included in the digital item transfer information is less than or equal to the backup resource amount,
a member identifier of the target member is recorded in an available member list configured in the backup resource information, or a digital item transfer time recorded in the digital item transfer information falls within an available time range in the backup resource information.

5. The method according to claim 3, wherein the performing digital item transfer interaction processing on the digital item transfer interaction request submitted by the institutional member based on the interaction tag, if the digital item transfer interaction request is received, includes:
in response to a confirmation request for the digital item transfer record is received from an institutional member other than the target member in the member group, updating the available resource amount in the backup resource information to the backup resource amount based on the confirmation request.

6. The method according to claim 3, wherein the backup resource information is configured as follows:
obtaining a backup resource allocation request of a target institutional member in the member group for the member group;
collecting, based on the backup resource allocation request, a backup update type configured by the target institutional member;
collecting a backup resource parameter uploaded by the target institutional member in the backup update type; and
determining, based on the backup update type and the backup resource parameter, the backup resource information allocated to the member group.

7. The method according to claim 6, wherein the available resource amount in the backup resource information is configured based on the backup update type included in the backup resource information; and
in response to the backup update type is a first update type, the available resource amount in the backup resource information remains unchanged.

8. The method according to claim 7, further comprising:
in response to the backup update type is a second update type, obtaining an update cycle condition included in the backup resource information;
calculating an update time for the available resource amount based on a digital item transfer time recorded in the digital item transfer record and the update cycle condition; and
in response to it is detected that the update time arrives, updating the available resource amount in the backup resource information to the backup resource amount.

9. The method according to claim 2, wherein the performing digital item transfer interaction processing on the digital item transfer interaction request submitted by the
institutional member based on the interaction tag, if the digital item transfer interaction request is received, includes:
in response to a write-off request for the digital item transfer record submitted by a target institutional member other than the target member in the member group is received, determining a resource account of the target institutional member;
transferring a resource corresponding to a digital item transfer resource amount recorded in the digital item transfer information in the resource account to a digital item transfer account of the target member; and
generating a write-off log for the digital item transfer record based on a resource transfer result and a member identifier of the target institutional member, and pushing the write-off log to display the write-off log in an interaction list of the member group.

10. The method according to claim 1, wherein the performing digital item transfer interaction processing on the digital item transfer interaction request submitted by the institutional member based on the interaction tag includes:
in response to a record voucher request for the digital item transfer record submitted by a target institutional member other than the target member in the member group is received, generating voucher addition reminder information based on a voucher type carried in the record voucher request, and pushing the information;
obtaining a record voucher uploaded by the target member based on the voucher addition reminder information, and associating the record voucher with the digital item transfer record; and
pushing the record voucher to display the record voucher in an interaction list of the member group.

11. The method according to claim 1, wherein the generating the digital item transfer interaction messages of the institutional members in the member group for the digital item transfer record based on the member permission of the institutional members includes:
determining, based on a digital item transfer type corresponding to the digital item transfer request, a co-ownership member that has co-ownership permission for the digital item transfer record in the institutional members; and
generating a review tag of the co-ownership member for the digital item transfer record based on the co-ownership permission, and generating a digital item transfer interaction message that includes the review tag.

12. The method according to claim 1, wherein an interaction tag of the target member is empty or a voucher submission tag; and
an interaction tag of an institutional member other than the target member in the member group includes a record confirmation tag, a record return tag, and/or a voucher request tag.

13. A digital item transfer interaction processing method, comprising:
receiving a digital item transfer instruction submitted by a target member in a member group of an institution by triggering a digital item transfer interface of the member group;
obtaining digital item transfer information collected for the digital item transfer instruction, generating a digital item transfer request, and submitting the digital item transfer request to a server;
receiving a digital item transfer interaction message that is delivered by the server and that carries an interaction tag of the target member, and displaying the digital item transfer interaction message in an interaction list of the member group; and
submitting a digital item transfer interaction request corresponding to the interaction tag to the server in response to it is detected that the interaction tag is triggered.

14. The method according to claim 13, wherein the receiving the digital item transfer instruction submitted by the target member in the member group of the institution by triggering the digital item transfer interface of the member group includes:
obtaining an access request of the target member for the member group, and displaying an access page based on the access request; and
receiving the digital item transfer instruction submitted by the target member by triggering an identification code collection component configured on the access page.

15. The method according to claim 14, wherein the obtaining the digital item transfer information collected for the digital item transfer instruction includes:
invoking a configured collection component to collect a collection identification code, and parsing the collection identification code; and
interacting with the target member based on a parsing result to obtain the digital item transfer information.

16. The method according to claim 13, wherein after receiving the digital item transfer request, the server performs operations including:
performing digital item transfer processing on the digital item transfer information carried in the digital item transfer request, and generating a digital item transfer record;
determining an interaction tag of the target member for the digital item transfer record based on member permission of the target member for the digital item transfer record; and
generating access information of the target member for the digital item transfer record based on the interaction tag, generating the digital item transfer interaction message that includes the access information, and delivering the digital item transfer interaction message to a member terminal of the target member.

17. The method according to claim 16, wherein the submitting the digital item transfer interaction request corresponding to the interaction tag to the server includes:
collecting a record voucher for the digital item transfer record based on a tag type of the interaction tag; and
submitting the record voucher to the server, so that the server associates the record voucher with the digital item transfer record.

18. The method according to claim 17, further comprising:
obtaining the record voucher delivered after the server associates the record voucher with the digital item transfer record; and
in response to the record voucher is of a video type, playing the record voucher.

19. The method according to claim 13, wherein the interaction tag is an interaction tag that is determined by the server and that is of the target member for a digital item transfer record obtained after digital item transfer processing is performed on the digital item transfer information.

20. A digital item transfer interaction processing device, comprising at least one processor and at least one storage configured to store computer-executable instructions, wherein when the computer-executable instructions are executed by the at least one processor, at least one the processor is enabled to, individually or collectively, perform operations including:
receiving a digital item transfer request submitted by a member terminal of a target member in a member group of an institution, wherein the digital item transfer request is generated after a digital item transfer interface configured for the member group is triggered;
performing digital item transfer processing on digital item transfer information carried in the digital item transfer request, and obtaining a digital item transfer record;
generating digital item transfer interaction messages of institutional members in the member group for the digital item transfer record based on member permission of the institutional members, wherein the digital item transfer interaction messages carry interaction tags of the corresponding institutional members; and
performing digital item transfer interaction processing on a digital item transfer interaction request submitted by any institutional member based on an interaction tag, if the digital item transfer interaction request is received.
